(19) United States
(12) Patent Application Publication
(10) Pub. No.: US 2007/0193535 A1
(43) Pub. Date: Aug. 23, 2007

(54) Method of Operating a Marine or Stationary Diesel Engine

(76) Inventors: Terence Garner, Didcot (GB); Martin James Willis, Bitterne (GB)

Correspondence Address: INFINEUM USA L.P., P.O. BOX 710, LINDEN, NJ, 07036, US

(21) Appl. No.: 11/560,489

(22) Filed: Dec. 7, 2006

(30) Foreign Application Priority Data
Nov. 25, 2005 (EP) 05270084.6

(51) Int. Cl. F02B 43/00

(52) U.S. Cl. 123/1 A; 508/391

(57) ABSTRACT

A method of operating a marine or stationary diesel engine is disclosed in which the engine is lubricated with a single cylinder lubricant that is fed at a substantially constant feed rate to the engine. When the engine runs on fuel having a sulphur level that requires more base than is available from the cylinder lubricant, at least one overbased detergent having a base number of greater than 150 mgKOH/g is added to the fuel.

The present invention concerns a method of operating a marine or stationary diesel engine.

The sulphur content in fuel varies dependent upon its geographical area of origin. For marine diesel engines, high sulphur fuel is fuel including more than 1.5 mass % of sulphur and low sulphur fuel is fuel including 1.5 mass % sulphur or less. Low sulphur fuels are usually required in and around ports and in legislated areas, whereas cheaper, high sulphur fuels can be used on the open seas.

If a marine diesel engine is run on high sulphur fuel, it needs to be lubricated using a cylinder lubricating oil having a base number of at least 70 mg KOH/g, as determined using ASTM D 2896. A cylinder lubricating oil having a lower base number could be used at an increased feed rate but the impact on cost would be severe because high lubricant feed rates would be needed. If, on the other hand, a marine diesel engine is run on low sulphur fuel, it can be lubricated using a cylinder lubricating oil having a base number of less than 70 mg KOH/g, such as, for example, 40 mg KOH/g. A cylinder lubricating oil having a base number of about 70 mg KOH/g could be used for a short period of time at a reduced feed rate but over a longer period of time deposits will form in the engine from excessive ash. Furthermore, a reduction of feed rate increases the risk of oil starvation and the risk of insufficient lubricant being available to provide a film between the piston and the liner. Thus, when fuels with different sulphur contents are used, marine engines require different cylinder lubricating oils, one having a high base number and one having a low base number, which need to be stored in separate tanks.

The aim of the present invention is to provide an improved method of operating a marine or stationary diesel engine. In particular, the aim of the present invention is to provide an improved method of operating a marine or stationary diesel engine that runs on different fuels having different sulphur levels, i.e. high and low sulphur fuels.

In accordance with the present invention there is provided a method of operating a marine or stationary diesel engine wherein the engine is lubricated with a single basic cylinder lubricant that is fed at a substantially constant feed rate to the engine and, when the engine runs on fuel having a sulphur level that requires more base than is available from the basic cylinder lubricant, at least one overbased detergent having a base number of greater than 150 mgKOH/g is added to the fuel.

An advantage of the present invention is that only one cylinder lubricating oil, i.e. a cylinder lubricating oil having a low base number, needs to be used in a marine diesel engine even if the engine runs on different fuels having different sulphur levels. Furthermore, only one storage tank is required for the cylinder lubricating oil.

Preferably the overbased metal detergent is selected from: an overbased metal phenate, an overbased metal sulphonate, an overbased metal salicylate or an overbased metal hybrid detergent. The overbased metal hybrid detergent is preferably selected from: an overbased metal phenate-sulphonate detergent or an overbased metal phenate-sulphonate-salicylate detergent. The metal is preferably an alkaline earth metal, preferably calcium. The overbased metal detergent preferably has a total base number of greater than 175, preferably greater than 200, more preferably greater than 245 mg KOH/g.

The cylinder lubricating oil preferably has a total base number of less than 100, preferably less than 70, more preferably less than 60, even more preferably less than 50, and most preferably from 25 to 45 mg KOH/g.

The overbased metal detergent is preferably added to the fuel oil at a treat rate of 1 to 10,000 ppm, preferably 100 to 1,000 ppm, more preferably 250 to 500 ppm.

The high sulphur fuel preferably has a sulphur content of more than 2 mass %, preferably more than 3 mass %.

In accordance with the present invention there is also provided a method of operating a marine or stationary diesel engine wherein the engine is lubricated with a single cylinder lubricant having a base number of less than 70 mg KOH/g that is fed at a substantially constant feed rate to the engine, and the engine runs on at least two fuels, a first fuel having a sulphur level of 1.5% or less and a second fuel having a sulphur level of more than 1.5%; the method including the step of adding at least one overbased detergent having a base number of greater than 150 mgKOH/g to the fuel having a sulphur level of more than 1.5%.

In accordance with the present invention there is also provided an operating system for a marine or stationary diesel engine, the system comprising:
a) one cylinder oil tank for storing a marine diesel cylinder lubricant;
b) a first fuel tank for storing a first fuel having a sulphur level of 1.5 mass % or less; and
c) a second fuel tank for storing a second fuel having a sulphur level of more than 1.5 mass % and including at least one overbased detergent having a base number of greater than 150 mgKOH/g;
wherein the marine or stationary diesel engine operates by using one single marine diesel cylinder lubricant that is fed at a substantially constant feed rate to the engine and at least two different fuels having different sulphur levels.

The present invention also concerns use of an overbased metal detergent having a total base number of greater than 150 mg KOH/g, preferably greater than 200 mg KOH/g, in a fuel having a sulphur level of greater than 1.5%, preferably greater than 2%, to reduce piston ring and cylinder liner wear in a marine or stationary diesel engine.

### BRIEF DESCRIPTION OF THE FIGURES

FIG. 1 shows the wear pattern for the marine diesel engine of Test 1 wherein the y-axis shows cylinder liner height in mm, and the x-axis shows wear in microns, ranging from 0 to 100 microns.

FIG. 2 shows the wear pattern for the marine diesel engine of Test 2 wherein the y-axis shows cylinder liner height in mm, and the x-axis shows wear in microns, ranging from 0 to 100 microns.

The invention will now be described in more detail as follows:

The Fuel

The fuel may be any one of a wide variety of fuels, particularly diesel fuel oils.

Such fuels include “middle distillate” fuel oil which refers to petroleum-based fuel oils obtainable in refining crude oil as the fraction from the light, kerosene or jet fuel, fraction to the heavy fuel oil fraction. These fuels may also comprise atmospheric or vacuum distillate, cracked gas oil or a blend, in any proportions, of straight run and thermally and/or catalytically cracked or hydrocracked distillate. Examples include hydrocracked streams, kerosene, jet fuel, diesel fuel, heating oil, visbroken gas oil, light cycle oil and vacuum gas oil. Such middle distillate fuel oils usually boil over a temperature range, generally within the range of 100° C. to 500° C. as measured according to ASTM D86, more especially between 150° C. and 400° C.

Preferably the fuel is residual fuel oil and the diesel engine is a marine diesel engine, which can be 2- or 4-stroke.

Suitable fuels generally boil within the range of about 100° C. to about 500° C., e.g. 150° to about 450° C., for example, those having a relatively high Final Boiling Point of above 360° C. (ASTM D-86). Such fuels contain a spread of hydrocarbons boiling over a temperature range, including n-alkanes which precipitate as wax as the fuel cools. They may be characterised by the temperatures at which various %'s of fuel have vaporised, e.g. 10% to 90%, being the interim temperatures at which a certain volume % of initial fuel has distilled. The difference between say 90% and 20% distillation temperature may be significant. They are also characterised by pour, cloud and CFPP to points, as well as their initial boiling point (IBP) and final boiling point (FBP), cetane number, viscosity and density. The petroleum fuel oil can comprise atmospheric distillate or vacuum distillate, or cracked gas oil or a blend in any proportion of straight run and thermally and/or catalytically cracked distillates.

The fuel may in particular have one or more of the following characteristics:
(i) a 95% distillation point (ASTM D86) of greater than 330° C., preferably greater than 360° C., more preferably greater than 400° C., and most preferably greater than 430° C.;
(ii) a cetane number (measured by ASTM D613) of less than 55, such as less than 53, preferably less than 49, more preferably less than 45, most preferably less than 40,
(iii) an aromatic content of greater than 15% wt, preferably greater than 25% and more preferably greater than 40%; and
(iv) a Ramsbottom carbon residue (by ASTM D 524) of greater than 0.01% mass, preferably greater than 0.15% mass, more preferably greater than 0.3% mass, such as 1% or 5% mass, and most preferably greater than 10% mass.

As described earlier, these fuels may in particular contain streams such as streams roduced from fluid catalytic cracking, such materials usually having a density @ 15° C. of 850 to 970, such as 900 to 970 kg/m³ and characterised by low cetane number values, typically ranging from 10 or lower to around 30 to 35; from thermal cracking processes, like visbreaking and coking, such streams typically having a density range @ 15° C. of 830 to 930 kg/m³ and a cetane value of 20 to 50; and from hydrocracking that uses severe conditions, e.g. temperature in excess of 400° C. coupled with pressures of 130 bars or greater, to produce streams characterised by cetane number from 45 to 60 and having a density range @ 15° C. from 800 to 860 kg/m³.

Typically, marine fuels accord with the standard specification ASTM D-2069 and may be either distillate or residual fuels as described within that specification, and may have a kinematic viscosity at 40° C. in cSt of at least 1.40.

The fuel may also be an animal or vegetable oil, or a mineral oil as described above in combination with an animal or vegetable oil. Fuels from animal or vegetable sources are known as biofuels and are obtained from a renewable source. Certain derivatives of vegetable oil, for example rapeseed oil, e.g. those obtained by saponification and re-esterification with a monohydric alcohol, may be used. It has recently been reported that mixtures of a rapeseed ester, for example, rapeseed methyl ester (RME), with petroleum distillate fuels in ratios oft for example, 10:90 or 5:95 by volume are likely to be commercially available.

Thus, a biofuel is a vegetable or animal oil or both or a derivative thereof particularly an oil comprising fatty acid and/or fatty acid esters.

Vegetable oils are mainly triglycerides of monocarboxylic acids, e.g. acids containing 10-25 carbon atoms and listed below: 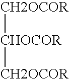
where R is an aliphatic radical of 10-25 carbon atoms which may be saturated or unsaturated.

Generally, such oils contain glycerides of a number of acids, the number and kind varying with the source vegetable of the oil.

Examples of oils are rapeseed oil, coriander oil, soyabean oil, cottonseed oil, sunflower oil, castor oil, olive oil, peanut oil, maize oil, almond oil, palm kernel oil, coconut oil, mustard seed oil, beef tallow and fish oils. Rapeseed oil, sunflower oil, soya bean oil and palm oil, is preferred as it is available in large quantities and can be obtained in a simple way by pressing from rapeseed.

Examples of derivatives thereof are alkyl esters, such as methyl esters, of fatty acids of the vegetable or animal oils. Such esters can be made by transesterification.

As lower alkyl esters of fatty acids, consideration may be given to the following, for example as commercial mixtures: the ethyl, propyl, butyl and especially methyl esters of fatty acids with 12 to 22 carbon atoms, for example of lauric acid, rosin acid (e.g. abietic acid and related structures such as dehydroabietic acid) myristic acid, palmitic acid, palmitoleic acid, stearic acid, oleic acid, elaidic acid, petroselic acid, ricinoleic acid, elaeostearic acid, linoleic acid, linolenic acid, eicosanoic acid, gadoleic acid, docosanoic acid or erucic acid, which have an iodine number from 50 to 180, especially 90 to 125. Mixtures with particularly advantageous properties are those which contain mainly, i.e. to at least 50 mass % methyl esters of fatty acids with 16 to 22 carbon atoms and 1, 2 or 3 double bonds. The preferred lower alkyl esters of fatty acids are the methyl esters of oleic acid, linoleic acid, Hinolenic acid and erucic acid, and mixtures thereof.

Commercial mixtures of the stated kind are obtained for example by cleavage and esterification of natural fats and oils by their transesterification with lower aliphatic alcohols. For production of lower alkyl esters of fatty acids it is advantageous to start from fats and oils with high iodine number, such as, for example, sunflower oil, rapeseed oil, coriander oil, castor oil, soyabean oil cottonseed oil, peanut oil, fall oil or beef tallow. Lower alkyl esters of fatty acids based on a new variety of rapeseed oil, the fatty acid component of which is derived to more than 80 mass % from unsaturated fatty acids with 18 carbon atoms, are preferred.

Preferably the biofuel is present in an amount of up to 50 mass % based on the mass of the middle distillate fuel oil, more preferably of up to 10 mass %, especially up to 5 mass %.

The fuel may alternatively be a fuel (either distillate or residual fuel) such as a heating fuel oil or powerplant fuel.

It is preferred that the fuel is a heavy fuel oil which is used for example in power generation and marine type applications which employ large engines and/or boilers or furnaces. It is also preferred that the fuel adheres to the ISO specification 8217:1996 and any modifications of said specification.

The Overbased Metal Detergent

A detergent is an additive that reduces formation of piston deposits, for example high-temperature varnish and lacquer deposits, in engines; it normally has acid-neutralising properties and is capable of keeping finely divided solids in suspension. Most detergents are based on metal “soaps”, that is metal salts of acidic organic compounds, sometimes referred to as surfactants.

Detergents generally comprise a polar head with a long hydrophobic tail, the polar head comprising a metal salt of an acidic organic compound. Large amounts of a metal base are included by reacting an excess of a metal compound, such as an oxide or hydroxide, with an acidic gas such as carbon dioxide to give an overbased detergent which comprises neutralised detergent as the outer layer of a metal base (e.g. carbonate) micelle.

Surfactants that may be used include phenates, salicylates, sulphonates, sulphurized phenates, thiophosphonates, and naphthenates and other oil-soluble carboxylates. The metal may be an alkali or alkaline earth metal, e.g., sodium, potassium, lithium, calcium, and magnesium Calcium is preferred

Surfactants for the surfactant system of the overbased metal compounds preferably contain at least one hydrocarbyl group, for example, as a substituent on an aromatic ring.

Phenate surfactants may be non-sulphurized or sulphurized. Phenate include those containing more than one hydroxyl group (for example, from alkyl catechols) or fused aromatic rings (for example, alkyl naphthols) and those which have been modified by chemical reaction, for example, alkylene-bridged and Mannich base-condensed and saligenin-type (produced by the reaction of a phenol and an aldehyde under basic conditions).

Preferred phenols on which the phenate surfactants are based may be derived from the formula I below: 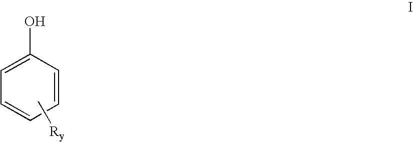
where R represents a hydrocarbyl group and y represents 1 to 4. Where y is greater than 1, the hydrocarbyl groups may be the same or different.

The phenols are frequently used in sulphurized form. Sulphurized hydrocarbyl phenols may typically be represented by the formula II below: 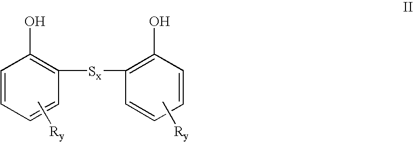
where x is generally from 1 to 4. In some cases, more than two phenol molecules may be linked by Sₓ bridges.

In the above formulae, hydrocarbyl groups represented by R are advantageously alkyl groups, which advantageously contain 5 to 100, preferably 5 to 40, especially 9 to 15, carbon atoms, the average number of carbon atoms in all of the R groups being at least about 9 in order to ensure adequate solubility in oil. Preferred alkyl groups are dodecyl (tetrapropylene) groups

In the following discussion, hydrocarbyl-substituted phenols will for convenience be referred to as alkyl phenols.

A sulphurizing agent for use in preparing a sulphurized phenol or phenate may be any compound or element which introduces —(S)ₓ— bridging groups between the alkyl phenol monomer groups, wherein x is generally from 1 to about 4. Thus, the reaction may be conducted with elemental sulphur or a halide thereof, for example, sulphur dichloride or, more preferably, sulphur monochloride. If elemental sulphur is used, the sulphurization reaction may be effected by heating the alkyl phenol compound at from 50 to 250, preferably at least 100, ° C. The use of elemental sulphur will typically yield a mixture of bridging groups —(S)_{X}— as described above. If a sulphur halide is used, the sulphurization reaction may be effected by treating the alkyl phenol at from −10 to 120, preferably at least 60, ° C. The reaction may be conducted in the presence of a suitable diluent. The diluent advantageously comprises a substantially inert organic diluent, for example mineral oil or an alkane. In any event, the reaction is conducted for a period of time sufficient to effect substantial reaction. It is generally preferred to employ from 0.1 to 5 moles of the alkyl phenol material per equivalent of sulphurizing agent.

Where elemental sulphur is used as the sulphurizing agent, it may be desirable to use a basic catalyst, for example, sodium hydroxide or an organic amine, preferably a heterocyclic amine (e.g., morpholine).

Details of sulphurization processes are well known to those skilled in the art.

Regardless of the manner in which they are prepared, sulphurized alkyl phenols generally comprise diluent and unreacted alkyl phenols and generally contain from 2 to 20, preferably 4 to 14, most preferably 6 to 12, mass % of sulphur, based on the mass of the sulphurized alkyl phenol.

As indicated above, the term “phenol” as used herein includes phenols which have been modified by chemical reaction with, for example, an aldehyde, and Mannich base-condensed phenols

Aldehydes with which phenols may be modified include, for example, formaldehyde, propionaldehyde and butyraldehyde. The preferred aldehyde is formaldehyde. Aldehyde-modified phenols suitable for use are described in, for example, U.S. Pat. No. 2,259,967.

Mannich base-condensed phenols are prepared by the reaction of a phenol, an aldehyde and an amine. Examples of suitable Mannich base-condensed phenols are described in GB-A-2 121 432.

In general, the phenols may include substituents other than those mentioned above provided that such substituents do not detract significantly from the surfactant properties of the phenols. Examples of such substituents are methoxy groups and halogen atoms.

Salicylic acids may be non-sulphurized or sulphurized, and may be chemically modified and/or contain additional substituents, for example, as discussed above for phenols. Processes similar to those described above may also be used for sulphurizing a hydrocarbyl-substituted salicylic acid, and are well known to those skilled in the art. Salicylic acids are typically prepared by the carboxylation, by the Kolbe-Schmift process, of phenoxides, and in that case, will generally be obtained (normally in a diluent) in admixture with uncarboxylated phenol.

Preferred substituents in oil-soluble salicylic acids from which overbased detergents may be derived are the substituents represented by R in the above discussion of phenols. In alkyl-substituted salicylic acids, the alkyl groups advantageously contain 5 to 100, preferably 9 to 30, especially 14 to 20, carbon atoms.

Sulphonic acids are typically obtained by sulphonation of hydrocarbyl-substituted, especially alkyl-substituted, aromatic hydrocarbons, for example, those obtained from the fractionation of petroleum by distillation and/or extraction, or by the alkylation of aromatic hydrocarbons. Examples include those obtained by alkylating benzene, toluene, xylene, naphthalene, biphenyl or their halogen derivatives, for example, chlorobenzene, chlorotoluene or chloronaphthalene. Alkylation of aromatic hydrocarbons may be carried out in the presence of a catalyst with alkylating agents having from 3 to more than 100 carbon atoms, such as, for example, haloparaffins, olefins that may be obtained by dehydrogenation of paraffins, and polyolefins, for example, polymers of ethylene, propylene, and/or butene. The alkylaryl sulphonic acids usually contain from 7 to 100 or more carbon atoms. They preferably contain from 16 to 80, or 12 to 40, carbon atoms per alkyl-substituted aromatic moiety, depending on the source from which they are obtained.

When neutralizing these alkylaryl sulphonic acids to provide sulphonates, hydrocarbon solvents and/or diluent oils may also be included in the reaction mixture, as well as promoters and viscosity control agents.

Another type of sulphonic acid comprises alkyl phenol sulphonic acids. Such sulphonic acids can be sulphurized. Whether sulphurized or non-sulphurized these sulphonic acids are believed to have surfactant properties comparable to those of sulphonic acids, rather than surfactant properties comparable to those of phenols,

Sulphonic acids also include alkyl sulphonic acids, such as alkenyl sulphonic acids. In such compounds the alkyl group suitably contains 9 to 100, advantageously 12 to 80 especially 16 to 60, carbon atoms.

Carboxylic acids include mono- and dicarboxylic acids. Preferred monocarboxylic acids are those containing 1 to 30, especially 8 to 24, carbon atoms. Examples of monocarboxylic acids are iso-octanoic acid, stearic acid, oleic acid, palmitic acid and behenic acid. Iso-octanoic acid may, if desired, be used in the form of the mixture of C₈ acid isomers sold by Exxon Chemicals under the trade name “Cekanoic”. Other suitable acids are those with tertiary substitution at the α-carbon atom and dicarboxylic acids with more than 2 carbon atoms separating the carboxylic groups. Further, dicarboxylic acids with more than 35, for example, 36 to 100, carbon atoms are also suitable. Unsaturated carboxylic acids can be sulphurized. Although salicylic acids contain a carboxylic group, for the purposes of the present invention they are considered to be a separate group of surfactants, and are not considered to be carboxylic acid surfactants. (Nor, although they contain a hydroxyl group, are they considered to be phenol surfactants.)

Examples of other surfactants which may be used in accordance with the invention include the following compounds, and derivatives thereof: naphthenic acids, especially naphthenic acids containing one or more alkyl groups, dialkylphosphonic acids, dialkylthiophosphonic acids, and dialkyldithiophosphoric acids, high molecular weight (preferably ethoxylated) alcohols, dithiocarbamic acids, thiophosphines, and dispersants. Surfactants of these types are well known to those skilled in the art. Surfactants of the hydrocarbyl-substituted carboxylalkylene-linked phenol type, or dihydrocarbyl esters of alkylene dicarboxylic acids, the alkylene group being substituted with a hydroxy group and an additional carboxylic acid group, or alkylene-linked polyaromatic molecules, the aromatic moieties whereof comprise at least one hydrocarbyl-substituted phenol and at least one carboxy phenol, may also be suitable for use in the present invention; such surfactants are described in EP-A-708 171.

Further examples of detergents are sulphurized alkaline earth metal hydrocarbyl phenates that have been modified by carboxylic acids such as stearic acid, for examples as described in EP-A-271 262 (LZ-Adibis); and phenolates as described in EP-A-750 659 (Chevron).

Detergents may have a low TBN (i.e. a TBN of less than 50), a medium TBN (i.e. a TBN of 50 to 150) or a high TBN (i.e. a TBN of greater than 150, such as 150-500). “TBN” (Total Base Number) is as measured by ASTM D2896. The present invention requires at least one overbased metal detergent having a base number at least 150, preferably at least 175, more preferably at least 200 and most preferably at least 245 mg KOH/g.

The detergent may also contain at least two surfactant groups, such as groups selected from phenol, sulphonic acid, carboxylic acid, salicylic acid and naphthenic acid, that may be obtained by manufacture of a hybrid material in which two or more different surfactant groups are incorporated during the overbasing process.

Examples of hybrid materials are an overbased calcium salt of surfactants phenol and sulphonic acid; an overbased calcium salt of surfactants phenol and carboxylic acid; an overbased calcium salt of surfactants phenol, sulphonic acid and salicylic acid; and an overbased calcium salt of surfactants phenol and salicylic acid.

By an “overbased calcium salt of surfactants” is meant an overbased detergent in which the metal cations of the oil-insoluble metal salt are essentially calcium cations. Small amounts of other cations may be present in the oil-insoluble metal salt, but typically at least 80, more typically at least 90, for example at least 95, mole %, of the cations in the oil-insoluble metal salt, are calcium ions. Cations other than calcium may be derived, for example, from the use in the manufacture of the overbased detergent of a surfactant salt in which the cation is a metal other than calcium. Preferably, the metal salt of the surfactant is also calcium.

Preferably, the TBN of the hybrid detergent is at least 300, such as at least 350, more preferably at least 400, most preferably in the range of from 400 to 600, such as up to 500 mg KOH/g.

In the instance where at least two overbased metal compounds are present, any suitable proportions by mass may be used, preferably the mass to mass proportion of any one overbased metal compound to any other metal overbased compound is in the range of from 5:95 to 95:5; such as from 90:10 to 10:90; more preferably from 20:80 to 80:20; especially from 70:30 to 30:70; advantageously from 60:40 to 40:60.

Particular examples of hybrid materials include, for example, those described in WO-A-97/46643; WO-A-97/46644; WO-A-97/46645; WO-A-97/46646; and WO-A-97/46647,

The detergent may also be, for example, a sulphurized and overbased mixture of a calcium alkyl phenate and a calcium alkyl salicylate: an example is described in EP-A-750,659, namely: a detergent-dispersant additive for lubricating oil of the sulphurised and superalkalinised, alkaline earth alkylsalicylate-alkylphenate type, characterised in that:
a) the alkyl substituents of the said alkylsalicylate-alkylphenate are in a proportion of at least 35 wt. % and at most 85 wt. % of linear alkyl in which the number of carbon atoms is between 12 and 40, preferably between 18 and 30 carbon atoms, with a maximum of 65 wt. % of branched alkyl in which the number of carbon atoms is between 9 and 24 and preferably 12 carbon atoms;
b) the proportion of alkylsalicylate in the alkylsalicylate-alkylphenate mixture is at least 22 mole % and preferably at least 25 mole %; and
c) the molar proportion of alkaline earth base with respect to alkylsalicylate-alkylphenate as a whole is between 1.0 and 3.5.

The overbased metal detergent is preferably added to the fuel oil at a treat rate of 1 to 10,000 ppm, preferably 100 to 1,000 ppm, more preferably 250 to 500 ppm.

The overbased detergent may be in admixture with a carrier liquid (e.g. as a solution or a dispersion). Such concentrates are convenient as a means for incorporating the metal detergents into bulk fuel oil such as distillate fuel oil, which incorporation may be done by methods known in the art. The concentrates may also contain other fuel additives as required and preferably contain from 1 to 75 mass %, more preferably 2 to 60 mass %, most preferably 5 to 50 mass % of the additives, based on active ingredient, preferably in solution in the carrier liquid. Examples of carrier liquids are organic solvents including hydrocarbon solvents, for example petroleum fractions such as naphtha, kerosene, lubricating oil, diesel fuel oil and heating oil; aromatic hydrocarbons such as aromatic fractions, e.g. those sold under the ‘SOLVESSO’ tradename; alcohols such as hexanol and higher alkanols; esters such as rapeseed methyl ester and paraffinic hydrocarbons such as hexane and pentane and isoparaffins. The carrier liquid must, of course, be selected having regard to its compatibility with the additives and with the fuel oil.

The detergents may be incorporated into the bulk fuel oil by other methods such as those known in the art. If co-additives are required, they may be incorporated into the bulk fuel oil at the same time as the metal compounds of the present invention or at a different time.

The detergents may be used in combination with one or more co-additives such as known in the art, for example the following: cold flow improvers, wax anti-settling agents, dispersants, antioxidants, corrosion inhibitors, dehazers, demulsifiers, metal deactivators, antifoaming agents, cetane improvers, cosolvents, package compatibilisers, other lubricity additives, biocides and antistatic additives.

Lubricating Oil

The lubricating oil preferably has a total base number of less than 70, preferably less than 60, more preferably less than 50 and most preferably 35 to 45 mg KOH/g as determined by ASTM D 2896.

The desired total base number can be achieved by adding appropriate amounts of an overbased detergent described above, A lubricating oil having a base number of 40, for example, can be produced by the use of a treat rate of 40% of an overbased detergent having a base number of 100.

The lubricating oil may also include at least one dispersant or at least one antiwear agent.

Dispersants

A dispersant is an additive for a lubricating oil whose primary function in lubricants is to accelerate neutralization of acids by the detergent system,

A noteworthy class of dispersants are “ashless”, meaning a non-metallic organic material that forms substantially no ash on combustion, in contrast to metal-containing, hence ash-forming, materials. Ash less dispersants comprise a long chain hydrocarbon with a polar head, the polarity being derived from inclusion of, e.g., an 0, P or N atom. The hydrocarbon is an oleophilic group that confers oil-solubility, having for example 40 to 500 carbon atoms. Thus, ashless dispersants may comprise an oil-soluble polymeric hydrocarbon backbone having functional groups that are capable of associating with particles to be dispersed.

Examples of ashless dispersants are succinimides, e.g. polyisobutene succinic anhydride; and polyamine condensation products that may be borated or unborated.

The dispersants may be used in a proportion in the range of 0 to 10.0, preferably 0.5 to 6.0, or more preferably 1.0 to 5.0, mass % based on the mass of the lubricating oil.

Antiwear Additives

The lubricating oil may include at least one antiwear additive. Dihydrocarbyl dithiophosphate metal salts constitute a known class of anti-wear additive. The metal in the dihydrocarbyl dithiophosphate metal may be an alkali or alkaline earth metal, or aluminium, lead, tin, molybdenum, manganese, nickel or copper. Zinc salts are preferred; preferably in the range of 0.1 to 1.5, preferably 0.5 to 1.3, mass %, based upon the total mass of the lubricating oil. They may be prepared in accordance with known techniques by first forming a dihydrocarbyl dithiophosphoric acid (DDPA), usually by reaction of one or more alcohol or a phenol with P₂S₅ and then neutralizing the formed DOPA with a zinc compound. For example, a dithiophosphoric acid may be made by reacting mixtures of primary and secondary alcohols. Alternatively, multiple dithiophosphoric acids can be prepared comprising both hydrocarbyl groups that are entirely secondary in character and hydrocarbyl groups that are entirely primary in character. To make the zinc salt, any basic or neutral zinc compound may be used but the oxides, hydroxides and carbonates are most generally employed. Commercial additives frequently contain an excess of zinc due to use of an excess of the basic zinc compound in the neutralization reaction.

The preferred zinc dihydrocarbyl dithiophosphates are oil-soluble salts of dihydrocarbyl dithiophosphoric acids and may be represented by the following formula:
[(RO)(R¹O)P(S)S]₂Zn
where R and R¹ may be the same or different hydrocarbyl radicals containing from 1 to 18, preferably 2 to 12, carbon atoms and including radicals such as alkyl, alkenyl, aryl, arylalkyl, alkaryl and cycloaliphatic radicals. Particularly preferred as R and R¹ groups are alkyl groups of 2 to 8 carbon atoms. Thus, the radicals may, for example, be ethyl, n-propyl, 1-propyl, n-butyl, 1-butyl, sec-butyl, amyl, n-hexyl, 1-hexyl, n-octyl, decyl, dodecyl, octadecyl, 2-ethylehexyl, phenyl, butylphenyl, cyclohexyl, methylcyclopentyl, propenyl, butenyl. In order to obtain oil-solubility, the total number of carbon atoms (i.e. in R and R¹) in the dithiophoshoric acid will generally be 5 or greater. The zinc dihydrocarbyl dithiophosphate can therefore comprise zinc dialkyl dithiophosphates.

The antiwear additive may be used in a proportion in the range of 0.1 to 1.5, preferably 0.2 to 1.3, or more preferably 0.3 to 0.8, mass % based on the mass of the lubricating oil.

The Marine or Stationary Diesel Engine

The engines may be two stroke or four stroke diesel engines. Such engines are found in a wide range of marine vessels and may also be found in stationary applications.

Of the four-stroke engines, particularly suitable engines are those having a power output of above 250 bhp, and especially those having an output over 600 bhp, such as over 1000 bhp. Especially suitable are those having cylinder bore dimensions of greater than 180 mm and piston strokes of greater than 180 mm and more preferably bores of greater than 240 mm and strokes of greater than 290 mm, such as bores of greater than 320 and strokes of greater than 320 mm, including the largest engines having bores of greater than 430 mm and strokes of greater than 600 mm.

Of the two-stroke engines, particularly suitable engines are those having a power output above 200 bhp and more preferably above 1000 bhp. Especially suitable are those engines having bores of greater than 240 mm, such as greater than 400 or 500 mm, and strokes of greater than 400 mm or 500 mm, such as greater than 1000 mm. Such large two-stroke engines include the “crosshead” type engines used in marine applications.

The invention will now be described, by way of example only, with reference to the following examples.

Testing was performed using the Bolnes 3(1) DNL 190 single cylinder test engine. The tests were run with a cylinder lubricant feed rate of 1.35 g/kWh for 96 hours using an engine speed of 500 rpm with an average power output of 110 kW.

Tests were conducted using:

1) Heavy fuel oil A (sulphur content 3.1 wt %) and a 70BN marine diesel cylinder lubricating oil; and
2) Heavy fuel oil A (sulphur content 3.1 wt %) including 367 ppm of an overbased calcium phenate detergent having a base number of 250, and a 40BN marine diesel cylinder lubricating oil.

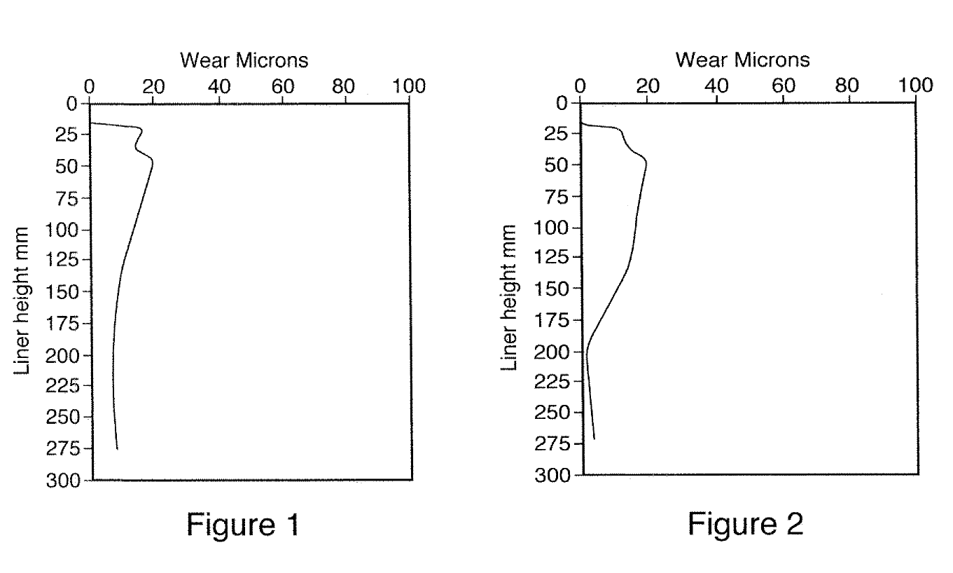

The test results were as follows:

| | | Test 2 |
|---|---|---|
| | | (See FIG. 2) |
| | Test 1 | 40 BN Marine Diesel |
| | (See FIG. 1) | Lubricant with Fuel A |
| Measured Engine | 70 BN Marine Diesel | including an |
| Parameter | Lubricant with Fuel A | Overbased Detergent |
| Ring wear/mm average | 0.05 | 0.04 |
| Cylinder Wear/mm | 0.013 | 0.012 |
| average mm FRT | | |
| Cylinder Wear/mm | 0.033 | 0.030 |
| Maximum mm FRT | | |

The wear patterns for Tests 1 and 2 are also shown in the attached FIGS. 1 and 2 respectively. The y-axis shows cylinder liner height in mm, ranging from 0 to 300 mm, and the x-axis shows wear in microns, ranging from 0 to 100 microns.

The data shows that a marine diesel cylinder lubricating oil having a base number of 40 mg KOH/g can be used in a marine diesel engine running on high sulphur fuel as long as the fuel includes an overbased detergent. Furthermore, the wear is less than that produced by the use of a marine diesel cylinder lubricating oil having a base number of 70 mg KOH/g in a marine diesel engine running on high sulphur fuel. Thus, the invention allows the use of a marine diesel cylinder lubricating oil having a low base number, i.e. less than 70, even if the sulphur content of the fuel, on which the engine is running, is high.

What is claimed is:

1. A method of operating a marine or stationary diesel engine wherein the engine is lubricated with a single cylinder lubricant that is fed at a substantially constant feed rate to the engine and, when the engine runs on fuel having a sulphur level that requires more base than is available from the cylinder lubricant, at least one overbased detergent having a base number of greater than 150 mg KOH/g is added to the fuel.

2. The method as claimed in claim 1, wherein the at least one overbased detergent having a base number of greater than 150 mg KOH/g is added to the fuel when said fuel has a sulphur level of greater than 1.5 mass %.

3. The method as claimed in claim 1, wherein the cylinder lubricant has a total base number (TBN) of less than 70 mg KOH/g.

4. The method as claimed in claim 1, wherein the overbased metal detergent is selected from: an overbased metal phenate, an overbased metal sulphonate, an overbased metal salicylate or an overbased metal hybrid detergent.

5. The method as claimed in claim 4, wherein the overbased metal detergent is an overbased metal hybrid detergent selected from the group consisting of overbased metal phenate-sulphonate detergent, and overbased metal phenate-sulphonate-salicylate detergent.

6. The method as claimed in claim 1, wherein the metal is an alkaline earth metal.

7. The method as claimed in claim 6, wherein the alkaline earth metal is calcium.

8. The method as claimed in claim 1, wherein the overbased metal detergent has a total base number of greater than 175 mg KOH/g.

9. The method as claimed in claim 8, wherein the overbased metal detergent has a total base number of greater than 200 mg KOH/g.

10. The method as claimed in claim 9, wherein the overbased metal detergent has a total base number of greater than 245 mg KOH/g.

11. The method as claimed in claim 1, wherein the cylinder lubricating oil has a total base number of less than 60 mg KOH/g.

12. The method as claimed in claim 11, wherein the cylinder lubricating oil has a total base number of less than 50 mg KOH/g.

13. The method as claimed in claim 12, wherein the cylinder lubricating oil has a total base number of 35 to 45 mg KOH/g.

14. The method as claimed in claim 1, wherein the overbased metal detergent is added to the fuel at a treat rate of 1 to 10,000 ppm.

15. The method as claimed in claim 14, wherein the overbased metal detergent is added to the fuel at a treat rate of 100 to 1,000 ppm.

16. The method as claimed in claim 15, wherein the overbased metal detergent is added to the fuel at a treat rate of 250 to 500 ppm.

17. The method as claimed in claim 1, wherein the fuel has a sulphur level of greater than 2 mass %.

18. The method as claimed in claim 17, wherein the fuel has a sulphur level of greater than 2.5 mass %.

19. The method as claimed in claim 18, wherein the fuel has a sulphur level of greater than 3 mass %.

20. The method as claimed in claim 15 for preventing piston ring wear or cylinder liner wear in a marine or stationary diesel engine.
